(19) United States
(12) Patent Application Publication
(10) Pub. No.: US 2002/0108762 A1
(43) Pub. Date: Aug. 15, 2002

(54) Working tool

(76) Inventor: Earl Lynch, Doraville, GA (US)

Correspondence Address: Dorian B. Kennedy, Baker, Donelson, Bearman & Caldwell, Suite 900, Five Concourse Parkway, Atlanta, GA, 30328, US

(21) Appl. No.: 09/781,701

(22) Filed: Feb. 13, 2001

(51) Int. Cl. A01B 45/00

(52) U.S. Cl. 172/22; 172/371; 172/37

(57) ABSTRACT

A working tool (10) is disclosed having an elongated shaft (11), a handle (12) mounted generally perpendicular to one end of the shaft (11), and a ground working head (13) mounted to an opposite, lower end of the shaft (11). The working tool (10) also includes an annular step plate (16) mounted upon the shaft for rotary movement relative to the shaft 11. An upper stop (7) and a lower stop (18) are also coupled to the shaft (11) above and below the step plate (16), respectively.

### TECHNICAL FIELD

This invention relates to working tools and especially to earth working tools which are rotated during use.

### BACKGROUND OF THE INVENTION

Rotating earth working tools and the like, such as post hole diggers and ground tilling claws, have existed for many years. These tools include a handle, a ground working head and an elongated shaft extending between the handle and working head. The handle is typically mounted perpendicular to the shaft so that an operator may impart a large rotational force upon the working head through manual rotation of the handle. It is difficult however to place a large downward force up the working head as any downward force upon the tool is provided through muscles within the operator's shoulder and upper arms and the weight of the operator's upper torso.

To provide a large downward force required to dig or cultivate hardened ground certain tools have been provided with foot steps. These foot steps enable an operator to place his or her foot thereon in order to shift the operator's weight to the working head, thus directing a downward force during use. These foot steps however can not be utilized with rotating tools as the position of the foot step would change with the operational movement of the tool, and thereby prevent the operator from continuously applying foot pressure to the step.

Accordingly, it is seen that a need remains for a rotating working tool which may be forced downwardly to work upon ground in an easy manner. It is the provision of such that the present invention is primarily directed.

### SUMMARY OF THE INVENTION

In a preferred form of the invention, a working tool comprises an elongated shaft, a handle mounted adjacent one end of the shaft, a working head mounted adjacent another end of the shaft, and a step plate rotatably coupled to the shaft for rotatable movement of the shaft relative to the step plate. With this construction, an operator may rotate the shaft and working head through manual rotation of the handle while providing a downward force upon the step plate in a stationary position with the operator's foot.

### BRIEF DESCRIPTION OF THE DRAWINGS

FIG. 1 is a perspective view of the working tool of the present invention.

FIG. 2 is a perspective view, in partial cross-section, of a lower portion of a working tool in another preferred form of the invention.

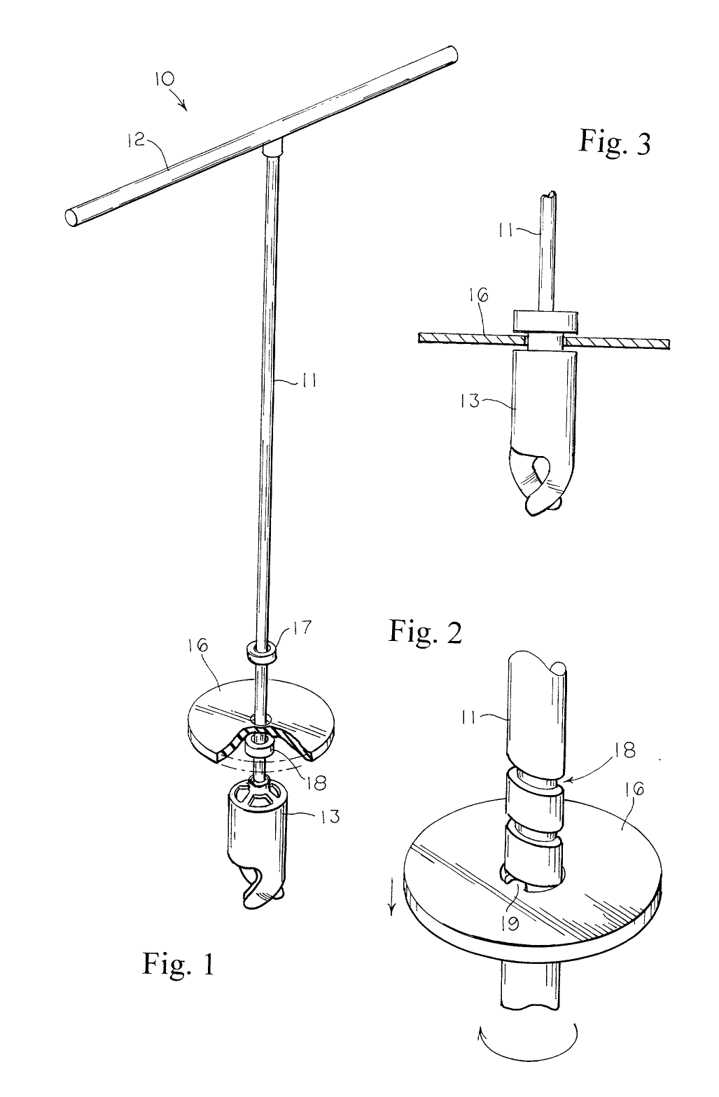

### DETAILED DESCRIPTION OF THE DRAWINGS

With reference next to the drawing there is shown a working tool 10 embodying principles of the invention in a preferred form. The working tool 10 has an elongated shaft 11, a handle 12 mounted generally perpendicular to and at an upper end of the shaft 11, and a ground working head 13 mounted to an opposite, lower end of the shaft 11. The ground working head 13 is shown here in the form of a post hole digger. The working tool 10 also includes an annular step plate 16 journally mounted upon the shaft for freely rotating movement relative to the shaft 11. An upper stop 17 and a lower stop 18 are also coupled to the shaft 11 above and below the step plate 16, respectively.

In use, an operator grasps opposite ends of the handle 12 and applies rotational force upon the handle 12 about the shaft, which in turn rotates the shaft 11 and ground working head 13. The operator also places one foot upon the step plate 16 and shifts a portion of his or her weight to that foot to provide a downward force upon the step plate 16. This downward force is transferred to the ground working head 13 through the shaft 11. In this manner, the handle 12, shaft 11 and working head 13 are manually rotated while the step plate 16 remains stationary, thereby enabling an operator to provide a continuous downward force upon the step plate 16, and thereby the working head 13, even though the remaining portions of the working tool 10 are being rotated.

It should be understood that once the working head 13 is extracted from the ground any dirt stuck to or within the working head may be jarred loose by quickly moving or banging the step plate 16 against either the upper and lower stops 17 and 18, respectively.

It should also be understood that the working head may be in the form of any type of rotating working tool head, such as a conventional ground breaking claw, auger, or other head designed to be coupled to a separate or detachable member rotated into the ground such as a helical anchoring stake. It should also be understood that as an equivalent structure the rotating step plate may be mounted directly to the working head rather than the shaft, as shown in FIG. 3. With reference next to FIG. 2, there is shown a shaft 11 and step plate 16 of the present invention in another preferred form. Here, the shaft 11 has a helical groove 18 and the step plate has a tongue 19 configured to ride within the helical groove 18.

In use, as the operator applies a downward pressure upon the step plate 16 the downward force of the tongue 19 riding upon the bottom surface of the groove 18 causes a rotational force upon the shaft 11. This rotational force aids the operator in rotating the working head coupled to the end of the shaft.

It thus is seen that a working tool is now provided which enables one to provide a large downward force while simultaneously rotating the working head of the tool. While this invention has been described in detail with particular references to the preferred embodiments thereof, it should be understood that many modifications, additions and deletions, in addition to those expressly recited, may be made thereto without departure from the spirit and scope of the invention as set forth in the following claims.

1. A working tool comprising:
a) an elongated shaft;
b) a handle mounted adjacent one end of said shaft;
c) a working head mounted adjacent another end of said shaft opposite said one end; and
d) a step plate rotatably coupled to said shaft for rotatable movement of said shaft relative to said step plate,
whereby an operator may rotate the shaft and working head through manual rotation of the handle while providing a downward force upon the step plate in a stationary position with the operator's foot.

2. The working tool of claim 1 wherein said shaft has at least one helical groove and wherein said step plate has a tongue configured to ride within said helical groove.

3. The working tool of claim 1 wherein said working head is a hole digging head.

4. The working tool of claim 1 further comprising a lower stop coupled to said shaft between said step plate and said working head, whereby the step plate may be forcefully moved against said lower stop to cause dirt to be shockably removed from said working head.

5. The working tool of claim 1 further comprising an upper stop coupled to said shaft between said step plate and said handle, whereby the step plate may be forcefully moved against said upper stop to cause dirt to be shockably removed from said working head.

6. The working tool of claim 4 further comprising an upper stop coupled to said shaft between said step plate and said handle, whereby the step plate may be forcefully moved against said upper stop to cause dirt to be shockably removed from said working head.

7. The working tool of claim 1 wherein said step plate is generally annular.

8. A working tool comprising:
(a) a handle;
(b) a shaft having one end coupled to said handle;
(c) a ground working head coupled to an opposite end of said shaft, and
(d) a step plate having an opening therein, said shaft being journal led through said step plate opening for rotatable movement of said shaft relative to said step plate,
whereby an operator may rotate the shaft and working head through manual rotation of the handle while providing a downward force upon the step plate in a stationary position with the operator's foot.

9. The working tool of claim 8 wherein said shaft has at least one helical groove and wherein said step plate has a tongue configured to ride within said helical groove.

10. The working tool of claim 8 wherein said working head is a hole digging head.

11. The working tool of claim 8 further comprising a lower stop coupled to said shaft between said step plate and said working head, whereby the step plate may be forcefully moved against said lower stop to cause dirt to be shockably removed from said working head.

12. The working tool of claim 8 further comprising an upper stop coupled to said shaft between said step plate and said handle, whereby the step plate may be forcefully moved against said upper stop to cause dirt to be shockably removed from said working head.

13. The working tool of claim 11 further comprising an upper stop coupled to said shaft between said step plate and said handle, whereby the step plate may be forcefully moved against said upper stop to cause dirt to be shockably removed from said working head.

14. The working tool of claim 8 wherein said step plate is generally annular.

15. A working tool comprising:
a) a shaft;
b) a handle mounted adjacent one end of said shaft;
c) a working head mounted adjacent another end of said shaft opposite said one end; and
d) a step plate rotatably coupled to said working head for rotatable movement of said step plate relative to said working head,
whereby an operator may rotate the shaft and working head through manual rotation of the handle while providing a downward force upon the step plate in a stationary position with the operator's foot.

16. The working tool of claim 15 wherein said working head is a hole digging head.

17. The working tool of claim 15 wherein said step plate is generally annular.
